(19) United States
(12) Patent Application Publication
(10) Pub. No.: US 2008/0243326 A1
(43) Pub. Date: Oct. 2, 2008

(54) Information Output System for a Vehicle and Associated Information Output Method

(76) Inventors: Guenter Dobler, Altbach (DE); Volker Entenmann, Affalterbach (DE); Siegfried Rothe, Denkendorf (DE); Cornelia Voigt, Schanbach-Aichwald (DE); Sven Willmann, Titisee-Neustadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/568,978

(22) PCT Filed: Aug. 12, 2004
(86) PCT No.: PCT/EP04/09027

§ 371 Date: Jun. 4, 2008

(30) Foreign Application Priority Data
Aug. 22, 2003 (DE) 10338566.5

(51) Int. Cl. B60R 16/02; B60Q 9/00; B60R 11/02; G08B 7/00; G08G 1/09

(52) U.S. Cl. 701/29

(57) ABSTRACT

An information output system of a vehicle senses the driving state and/or the surroundings state of the vehicle, of outputs information using at least two sensory channels, and evaluates and controls collected data, to actuate the output of information as a function of the data evaluation. At, least one of the at least two sensory channels can be selected for the outputting of information. The evaluation and control unit evaluates the collected data to determine, whether a collision with the outputting of a second information item occurs with the sensory channel selected for outputting a first information item, and when a collision is detected changes over the sensory channel to outputting the first or the second information item, or when the first and the second information item is output using the same sensory channel the time required for outputting the first and second information items is determined and the outputting of the information item with the longer time requirement is delayed compared to the outputting of the information item with the shorter time requirement.

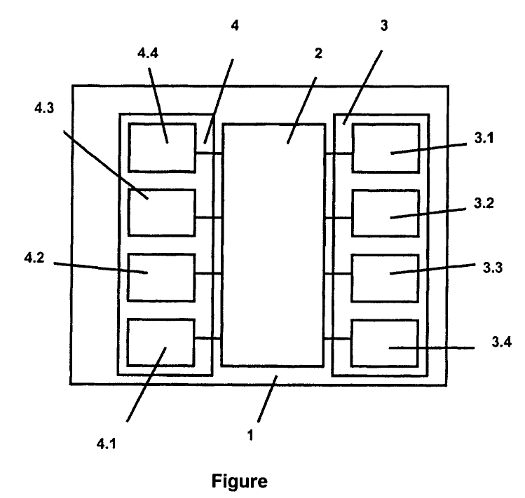

### BACKGROUND AND SUMMARY OF THE INVENTION

The present invention relates to an information output system of a vehicle having means for sensing the driving state and/or the state of the surroundings of the vehicle, means for outputting of information using at least two sensory channels, an evaluation and control unit for processing and evaluating the collected data, and for actuating the means for the outputting of information as a function of the data evaluation wherein at least one of the at least two sensory channels can be selected for the outputting of information, and to an associated information output method.

In contemporary vehicles, the outputting of information by a vehicle subsystem, for example a navigation system, is coordinated with the outputting of information by other vehicle subsystems (such as, for example, audio systems and/or communication systems), only to such an extent that when messages or events (for example, a turning instruction from the navigation system and an incoming telephone call) are present simultaneously, the messages are prioritized according to their urgency in order to avoid overlapping.

In the above-mentioned example it is therefore possible to suppress the acoustic turning instruction from the navigation system if the telephone is given a higher priority. In addition, the turning instruction may be lost if the driver has actuated only the audible information output of the navigation system. This may mean that the driver does not receive any turning instruction and thus leaves the route predefined by the navigation system without noticing. Even if the driver has activated the visual navigation output, which, for example, outputs navigation instructions in the form of direction arrows on a display unit of a combination instrument, the distraction by the incoming telephone call may cause the driver to fail to perceive the visual turning instruction and depart from the predefined route.

In addition, as a result of the lack of coordination of the information outputs from the various vehicle subsystems it is possible for confusing situations to arise. Fault messages which relate to the immediate operational reliability of the vehicle (such messages being, for example, a low engine oil level) normally have a high priority, i.e. they are usually output immediately to the driver. The driver is alerted to their appearance on the combination display by, for example, a signal tone. Situations may then arise in which the driver receives such a fault message and immediately afterwards an audible turning instruction from the navigation system is output, for example “turn right in 300 m”. After the request by the signal tone, the driver therefore reads on the display unit in the combination instrument that the engine oil level is too low and virtually at the same time reads that the driver is supposed to turn right. This can lead to confusion on the part of the driver since under certain circumstances the turning instruction is understood as a request to act in relation to the fault message even though the turning instruction has nothing to do with the low engine oil level.

DE 100 01 263 C2 relates to a vehicle voice-based information output system which collects data about the driving state and/or the state of the surroundings of the vehicle and outputs information from various vehicle subsystems such as, for example, an air conditioning system, audio system, navigation system etc., by way of voice output as a function of the collected data. Additionally or alternatively, a visual and a haptic sensory channel are specified for the outputting of information. There is no description of the information outputs from the various vehicle subsystems being coordinated.

DE 101 03 401 A1 relates to a hazard prevention system for a vehicle. In connection with the hazard prevention system, there is a description of the outputting of information or warning messages, for which a suitable sensory channel is selected for the outputting process as a function of the load on the driver, i.e. when there is a heavy acoustic load a visual, haptic or olfactory sensory channel is selected for the outputting process, and when there is a heavy visual load on the driver an auditory, haptic or olfactory sensory channel is selected. In addition, the outputting of the information or warning messages can be brought forward in order to output them in good time before there is an anticipated, increased load on the driver, or the outputting process can be delayed so that said information or warning messages are not output until after a brief, increased load on the driver. In order to determine the load on the driver, complex evaluation of the collected data is carried out.

An object of the present invention is to provide an information output system for a vehicle which coordinates better information to be output from various vehicle subsystems so that the driver is subject to a smaller load and a loss of information is virtually avoided, and to specify an associated information output method.

This object has been achieved by making available an information output system wherein the evaluation and control unit evaluates the collected data to determine whether a collision with the outputting of a second information time occurs with the sensory channel selected for outputting a first information item, and when a collision is detected changes over the sensory channel to outputting the first or the second information item, or when the first and the second information time is output using the same sensory channel the time required for outputting the first and second information items is determined and the outputting of the information item with the longer time requirement is delayed compared to the outputting of the information item with the shorter time requirement, in which case if the time requirements are the same, the information item with a higher priority is output first, and by an information output method wherein the collected data is evaluated to determine whether a collision with the outputting of a second information item occurs with the sensory channel selected for outputting a first information item, and when a collision is detected changes over the sensory channel to outputting the first or the second information item or when the first and the second information item is output using the same sensory channel the time required for outputting the first and second information items is determined and the outputting of the information item with the longer time requirement is delayed compared to the outputting of the information item with the shorter time requirements, in which case if the time requirements are the same, the information item with a higher priority is output first.

The present invention is based on the recognition that collected data relating to a driving state and/or a state of the surroundings of the vehicle should be evaluated to determine whether a collision with the outputting of a second information item occurs with the sensory channel selected for outputting a first information item. If such a collision is detected during this evaluation, the sensory channel for outputting the first or the second information item is changed over. Alternatively, during the outputting of the first and second information items using the same sensory channel the time of the outputting of the first or the second information item is shifted so that the outputting of the information item with the longer time requirement is delayed compared to the outputting of the information item with the shorter time requirement. The evaluation of the data and the determination of the time requirement for the outputting of the first and second information items is carried out by an evaluation and control unit.

As a result, the information outputs from different vehicle systems can be coordinated better with virtually no loss of information. An existing priority for the outputting of information can be taken into account to the effect that the sensory channel for the outputting of information which has the lower priority is changed, while the information output with the higher priority is output using its preferred sensory channel.

If the same sensory channel is used for outputting the first and second information items, the priority can be discounted if the information output with the lower priority has a shorter time requirement than the information output with the higher priority.

Changing over the sensory channel for the outputting of information can be indicated to the driver visually and/or audibly and/or haptically and/or olfactorily.

In one refinement of the information output system, the preferred sensory channel for outputting information from a vehicle subsystem can be preset by the driver and/or by the manufacturer.

If the evaluation and control unit does not detect any collision with other information outputs during the collision evaluation, for the purpose of outputting the first information item, the unit then selects the preferred sensory channel for the outputting of this information item.

In one development of the information output system, the evaluation and control unit determines, from the collected data, load states of the driver with respect to the at least two sensory channels. At least one sensory channel for the outputting of information is selected as a function of the determined load. As a result, the preferred sensory channel can be adapted to the current conditions in the vehicle or in the surroundings of the vehicle if the driver would be loaded too heavily by the outputting of information by means of the preferred sensory channel. A heavy load on the visual sensory channel is detected, for example, if a high traffic density and/or poor visibility are present. The evaluation and control unit then changes over to the outputting of information on the auditory sensory channel, for example. If the evaluation and control unit additionally determines a collision with another information output, the sensory channel or the time for the outputting of information can then be changed once more.

After the elimination of the collision or the load, the evaluation and control unit resets the preferred sensory channel for outputting future information items from the associated vehicle subsystem.

In one advantageous embodiment of the information output system, the first information items to be output are from a navigation system, and in this context these first information items are output brought forward in terms of time or delayed compared to second information items to be output by other vehicle systems.

The outputs of information by the navigation system are particularly well suited for the change in the output times because the navigation instructions generally occur very early, for example at a distance of 300 m from the next intersection, and can either be brought forward in terms of time or delayed without adversely affecting the support provided to the driver.

If, for example, a fault message, which normally has a very short duration and a very high priority, and a navigation instruction occur simultaneously, the outputting of the navigation instruction is delayed compared to the outputting of the fault message.

If an incoming telephone call, which normally requires a relatively long duration and has a relatively high priority, and a navigation instruction occur simultaneously, the navigation instruction is brought forward.

In order to adapt the information to be output by the navigation system to the change in time, the evaluation and control unit evaluates the information from the navigation system continuously.

The information output method according to the invention in a vehicle collects, processes and evaluates data relating to the driving state and/or the state of the surroundings of the vehicle. At least one sensory channel for outputting information is selected as a function of the data evaluation. In addition, the collected data is evaluated to determine whether a collision with the outputting of a second information item occurs with the sensory channel selected for outputting a first information item. If such a collision is detected, the sensory channel for outputting the first or the second information item is changed, or during the outputting of the first and second information items using the same sensory channel, the time requirement for outputting the first and second information items is determined and the information with the longer time requirement is output with a delay compared to the information with the shorter time requirement.

Other objects, advantages and novel features of the present invention will become apparent from the following detailed description of the invention when considered in conjunction with the accompanying drawings.

### BRIEF DESCRIPTION OF THE DRAWING

The sole FIGURE is a schematic block circuit diagram of an information output system for a vehicle according to the present invention.

### DETAILED DESCRIPTION OF THE DRAWING

As is apparent from the sole FIGURE, the information output system 1 of a vehicle comprises air circuitry 3 for collecting data relating to the driving state and/or the state of the surroundings of the vehicle, circuitry 4 for outputting information and an evaluation and control unit 2.

Vehicle state data is understood here to be, for example, data relating to the velocity of the vehicle, yaw acceleration, longitudinal acceleration and lateral acceleration, position of the brake pedal and position of the accelerator pedal, steering angle, the status of operator control elements and the status of sensors and control devices.

Data relating to the surroundings refers to data which is made available by sensors for the surroundings, telematics systems and by a vehicle-mounted communication system which communicates with other vehicles and/or fixed communication systems. Examples of data relating to the surroundings are information relating to the current location, for example indicating whether the stretch of road being traveled on is located in a residential area, at the edge of a wood or on a bridge, information relating to the category of road, for example indicating whether the road being traveled on is a freeway, a secondary road, a single lane road, multilane road, with or without oncoming traffic, and information relating to the lane on which the driver's vehicle is traveling. Further data relating to the surroundings comprises the state of the road, temperature, weather conditions, light conditions, noises in the surroundings, air quality and wind conditions, velocity, distance, direction of movement, type and state of vehicles, or other road users who are traveling ahead, adjacent, traveling behind or are oncoming.

Vehicle subsystems such as a navigation system 3.1, a communication system 3.2, sensors 3.3 for the surroundings and control devices 3.4 are illustrated, by way of example, as circuitry 3 for collecting such data.

The evaluation and control unit 2 processes such data and evaluates such data. As a function of the evaluation, the evaluation and control unit 2 controls the circuitry 4 for outputting information and, in order to output an information item, selects at least one sensory channel of the circuitry 4 for outputting information. In order to output an information item from one of the vehicle subsystems, a preferred sensory channel which is preset for the relevant information or for the respective vehicle subsystem by the driver or by the manufacturer is selected.

Before the information is output using the selected sensory channel, according to the invention the evaluation and control unit evaluates the collected data to determine whether a collision occurs with the outputting of a second information item with the sensory channel selected for outputting a first information item. If such a collision is detected, for example because the corresponding sensory channel is already being used by another system, the selected sensory channel for outputting the first or the second information item is then changed or the outputting of the first or the second information item is shifted in terms of time during the outputting of the first and second information items using the same sensory channel so that the outputting of the information with the longer time requirement is delayed compared to the outputting of information with the shorter time requirement. The determination of the time requirement for the outputting of the first and second information items is also carried out by the evaluation and control unit 2.

Of course, a plurality of sensory channels can also be used to output an information item, for example a visual and an auditory sensory channel can be used, and according to the invention they are then checked for a collision.

The circuitry 4 for outputting information comprise an audible output unit 4.1 for using the auditory sensory channel of the driver, which output unit 4.1 comprises, for example, a speech output unit and a unit for generating and outputting various tones using one or more loudspeakers, a visual output unit 4.2 for using the visual sensory channel of the driver, which output unit 4.2 comprises, for example, a screen display and/or a multifunction display, a haptic output unit 4.3 for using the haptic sensory channel of the driver, and an olfactory output unit 4.4 for using the olfactory sensory channel of the driver.

The changing of the sensory channel for the outputting of information is indicated to the driver visually and/or audibly and/or haptically and/or olfactorily using the circuitry 4 for outputting information, preferably the preset sensory channel for this vehicle subsystem being used to indicate the change.

When a change is necessary from the auditory sensory channel to the visual sensory channel, the change is carried out, for example, by way of an instruction tone which requests the driver to look at the visual output unit 4.2. At the same time, for example the direction information to be output by the navigation system 3.2 appears there in the form of a display with direction arrows and distance indications.

The change from the visual channel to the auditory channel can be carried out, for example, by a voice output “modality change for navigation instructions” from the audible output unit 4.1 which informs the driver about the change.

In addition, the evaluation and control unit 2 in the illustrated information output system determines, from the collected data, load states of the driver with respect to the selectable sensory channels. The determined load is included, in addition to the collision check, in the selection of the sensory channel for outputting information.

Thus, for example the preset preferred visual sensory channel is changed, when there is a large visual load on the driver, for example due to poor visibility or a large traffic volume, to the auditory and/or haptic and/or olfactory sensory channel.

After the elimination of the collision or the load, the evaluation and control unit 2 resets the preferred sensory channel for the outputting of future information items from the respective vehicle subsystem.

In particular information items which are to be output by the navigation system are suitable for shifting output times because the navigation instructions generally occur very early, for example at a distance of 300 m from the next intersection and can either be brought forward in terms of time or delayed without adversely affecting the assistance provided to the driver.

A method of operation of the information output system of the present invention will now be described below using the following illustrations. For example, the driver has activated the navigation system 3.1 and is located in the vehicle 500 m before an intersection at which a turn to the right has to be made. At this moment, a telephone call is received via the communication system 3.2. The evaluation and control unit 2 detects, by evaluating the data, that the driver is approaching an intersection and must turn there, and if the telephone call is accepted the corresponding, preset audible output of the information items from the navigation system 3.1 would collide with the telephone call. After the anticipated duration of the outputting of information has been determined, the evaluation and control unit 2 detects that the outputting of the first information item, here the direction instruction from the navigation system 3.1, is shorter than the outputting of the second information item, here the use of the auditory sensory channel by the accepted telephone call. For this reason, the evaluation and control unit suppresses the telephone call which has been received in the vehicle, by an amount of time which is sufficient to output the first information item, for example by 5 seconds. At the same time, the direction instruction from the navigation system is brought forward in terms of time and the driver receives the audible request “turn right in 500 m”. Only after this is the telephone call put through. After the telephone call has been accepted, for example the preset, preferred auditory sensory channel for outputting the navigation information items is changed to the visual sensory channel. This is communicated to the driver by an instruction tone.

By bringing the audible navigation output forward, 300 m has become 500 m, the driver's awareness of the situation is significantly improved because it is now known that the driver must turn off soon and also if no further audible navigation information is output by the accepted telephone call, greater attention can be paid to the visual outputting of the navigation information items.

If a fault message and a navigation output occur simultaneously, the evaluation and control unit 2 determines the duration of the respective information output, and since these are of approximately equal length and the fault message has the higher priority, it is output immediately. In order to give the driver sufficient time to perceive and process this message, the outputting of the navigation information is delayed. “Turn right in 300 m” becomes, for example, “turn right in 150 m”. This still leaves enough time and permits the driver to concern himself or herself exclusively with the fault message at that moment.

In order to improve even further the coordination of the outputting of navigation information items and the outputting of information from other vehicle subsystems, the evaluation and control unit 2 evaluates the information from the navigation system continuously so that, for the outputting, it can be adapted better to the change in time, for example in order to include the current distances in the text of the voice output.

The information output method includes the steps of sensing the driving state and/or of the state of the surroundings of the vehicle, processing and evaluating the collected data, selecting at least one sensory channel as a function of the data evaluation and outputting information using the selected sensory channel. The collected data is evaluated to determine whether a collision with the outputting of a second information item occurs with the sensory channel selected for outputting a first information item. If such a collision is detected, the sensory channel for outputting the first or the second information item is changed or a time requirement for outputting the first and the second information items is determined during the outputting of the first and second information items using the same sensory channel, and the information with the longer time requirement is output with a delay compared to the information with the shorter time requirement, in which case, when the time requirements are identical, the information with the higher priority is output.

Since information which is to be output from different vehicle systems is coordinated when collisions occur, i.e. its time is shifted or it is output using a different sensory channel, a loss of information can be virtually always prevented and the driver can be supported better in her tasks.

1-12. (canceled)

13. A vehicle information output system comprising a subsystem for sensing driving state and/or state of the surroundings of the vehicle, a subsystem for outputting of information using at least two sensory channels, an evaluation and control unit for processing and evaluating the collected data, and for actuating the subsystem for information the outputting as a function of the data evaluation with at least one of the at least two sensory channels selectable for the information outputting, wherein the evaluation and control unit is configured to evaluate the collected data to determine whether a collision with outputting of a second information item occurs with the sensory channel selected for outputting a first information item, and when a collision is detected changes over the sensory channel to output the first or the second information item, or when the first and the second information item is output using the same sensory channel a time required for outputting the first and second information items is determined and output the information item with the longer time requirement is delayed compared to the outputting of the information item with the shorter time requirement, such that if the time requirements are the same, the information item with a higher priority is output first.

14. The vehicle information output system as claimed in claim 13, wherein the changeover of the sensory channel for the outputting of information can be indicated to the drive at least one of visually, audibly, haptically and olfactorily.

15. The vehicle information output system as claimed in claim 13, wherein a preferred sensory channel for the outputting of information from a vehicle subsystem can be preset by the at least one of the driver and the vehicle manufacturer.

16. The vehicle information output system as claimed in claim 15, wherein, to output the first information item, the evaluation and control unit selects the preferred sensory channel for outputting this information item if, during the collision evaluation, no collision with other information outputs is detected

17. The vehicle information output system as claimed in claim 13, wherein the valuation and control unit is configured to determine, from the collected data, load states of the driver with respect to the at least two sensory channels and to select at least one sensory channel for the outputting of information as a function of the determined load.

18. The vehicle information output system as claimed in claim 15, wherein, after the collision has been eliminated, the evaluation and control unit resets the preferred sensory channel for the outputting of future information from the associated vehicle subsystem.

19. The vehicle information output as claimed in claim 17, wherein, after the load has been eliminated, the evaluation and control unit resets the preferred sensory channel for the outputting of future information from the associated vehicle subsystem.

20. The vehicle information output system as claimed in claim 13, wherein the first information item which is to be output is from a navigation system which, with respect to the outputting of information, is moved forward in terms of timing or delayed compared to second information items to be output by other vehicle systems.

21. The vehicle information output system as claimed in claim 20, wherein the navigation information is output with a delay compared to fault messages and is output brought forward in terms of timing compared to an incoming telephone call.

22. The vehicle information output system as claimed in claim 20, wherein the evaluation and control unit continuously evaluates the information from the navigation system in order to adapt the information to a change in timing of the outputting process.

23. A vehicle information output process, comprising sensing at least one of a driving state and state of vehicle surroundings, processing and evaluating the collected data, selecting at least one sensory channel as a function of the evaluated data, and outputting information about the selected sensor channel, wherein the collected data is evaluated to determine whether a collision with outputting of a second information item occurs with the sensory channel selected for outputting a first information item, and (a) when a collision is detected, changes over the sensory channel to outputting the first or the second information item or (b) when the first and the second information item is output using the same sensory channel, the time required for outputting the first and second information items is determined and the outputting of the information item with a longer time requirement is delayed compared to the outputting of the information item with a shorter time requirement such that, if the time requirements are the same, the information item with a higher priority is output first.

24. The vehicle information output method as claimed in claim 23, wherein, in order to select the sensory channel for the outputting of information from the collected data, load states of the vehicle with respect to the sensory channels are determined, wherein the sensory channel with the smallest load state is selected for the outputting of information.

25. The vehicle information output method as claimed in claim 23, wherein the change of the sensory channel for outputting information is indicated to the driver at least one of visually, audibly, haptically and olfactorily.

26. The vehicle information output method as claimed in claim 25, wherein, in order to select the sensory channel for the outputting of information from the collected data, load states of the vehicle with respect to the sensory channels are determined, wherein the sensory channel with the smallest load state is selected for the outputting of information.
